(19) United States
(12) Patent Application Publication
(10) Pub. No.: US 2006/0057347 A1
(43) Pub. Date: Mar. 16, 2006

(54) Cavitated opaque polymer film and methods related thereto

(76) Inventors: Jo Ann H. Squier, Bloomfield, NY (US); Mark W. Lockhart, Fairport, NY (US); Robert M. Sheppard, Victor, NY (US); Jason F. Chaneske, Canandaigua, NY (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/214,146

(22) Filed: Aug. 29, 2005

Related U.S. Application Data
(60) Provisional application No. 60/608,855, filed on Sep. 10, 2004.

(51) Int. Cl. B32B 27/32; B32B 27/08; B32B 27/30

(52) U.S. Cl. 428/220; 428/523; 428/522; 428/516; 428/343; 264/173.19

(57) ABSTRACT

A cavitated opaque polymer film, including (i) a beta-cavitated core layer containing a propylene polymer and an impact copolymer and (ii) a matte surface layer with sufficient roughness to serve as a mold-ready skin layer. The core layer may optionally contain a beta cavitating agent. Cavitated opaque labels including: a cavitated core layer; a support layer on one side of the core layer, the support layer containing a thermoplastic polymer; and a matte layer on the side of the core layer opposite the support layer. The core layer contains a propylene polymer, a beta nucleating agent, and an impact copolymer; the matte layer contains at least one of a matte-resin and a matte-surface producing agent. The matte surface outer layer may provide sufficient roughness to provide labels that are mold-ready for IML applications, without need for an adhesive pattern or coating.

### CROSS REFERENCE TO RELATED APPLICATIONS

This application claims benefit to provisional U.S. Patent Application No. 60/608,855, filed Sep. 10, 2004.

### FIELD OF THE INVENTION

The present invention relates to a cavitated, opaque polymer film. The film may have applications as a thick film and as a label film, such as an in-mold label (“IML”) film. In particular, the present invention relates to a cavitated opaque polymer film containing (i) a polymer core layer comprising a propylene polymer and an impact copolymer, wherein the core layer has been cavitated via beta-cavitation and (ii) a matte outer layer exhibiting sufficient roughness for the film to serve as a mold-ready label film.

### BACKGROUND OF THE INVENTION

The market for polymer films as labels and/or as flexible packaging films continues to expand. Exemplary areas of growth are in the food and beverage industries; health, beauty and cosmetics industries (e.g., shampoos, lotions); and automotive products industries (e.g., motor oil, coolants). Polymer films are increasingly being used as labels in these and other industries in part due to their printability, durability, and their ability to conform and adhere to the surface of a package or container. To facilitate improved durability and a “labelless” look, many end-users prefer using an IML label and application, wherein the label is inserted into a mold cavity before a polymeric bottle or container is either injection molded or blown therein. During forming the container, the label may become substantially, integrally bonded with the container.

A preferred label, is often opaque (e.g., substantially low- to non-transparent) and/or colored, (e.g., a “white” opaque label). Polymer films, on the other hand, especially polyolefin films, are inherently clear and colorless. Therefore, polymer films to be used as labels are generally modified to render them opaque and/or colored. A variety of techniques are known to modify a polymer film and render it opaque and/or colored. For example, conventional cavitation is well known in the art, wherein an organic or inorganic cavitating agents or particles are dispersed within the polymer matrix in one or more layers of a polymer film. The presence of the cavitating agent in a layer of the film during orientation induces voids or “cavities” in the polymeric material comprising the layer. During orientation, cavities are created at the situs of each of the particles, creating a cavitated film. After orientation, the voids scatter light passing through the film, thereby causing the film to be opaque. Exemplary organic, conventional cavitating agents may include polyesters, such as polyethylene terephthalate (PET) or polybutylene terephthalate (PBT). An exemplary inorganic conventional cavitating agent may include calcium carbonate (CaCO₃).

U.S. Pat. No. 4,632,869 to Park et al., discloses an opaque, biaxially oriented film structure containing a voided polymer matrix layer, in which the voids contain void-initiating particles of polybutylene terephthalate (PBT). The structure may also include thermoplastic skin layers, and the individual layers may include coloring pigments, such as TiO₂ (white) or colored oxides.

However, the use of CaCO₃- or PBT-type cavitating agents to induce voids in a polymer film, as proposed by US '869 and others like it, is an example of a conventional cavitation method. Conventional cavitation of this type tends to yield pore sizes that are a function of the cavitating agent particle size and tend to have a relatively wide distribution-range of pore sizes. The particles are typically in excess of greater than one micron in size and commonly in the range of excess of three to ten microns in size. This tends to produce pore sizes that are relatively large as compared to the size of polymer crystals and as compared to voids that may be created by other cavitation methods, such as beta cavitation, discussed below. As compared to uncavitated and beta cavitated films of similar gauge thickness, conventionally cavitated films tend to be less stiff and less tear-resistant. As a result, for some film applications requiring rather stiff, strong, and/or resilient mechanical properties, the performance of the conventionally cavitated film may be disappointing or wholly inadequate. Such films may result in performance deficiencies, such as poor resistance to permanent deformation, creasing, wrinkling, buckling, and/or shrinkage, when the film is subjected to bending and creasing stresses. In addition, single component cavitation of this type may tend to yield a non-uniform void distribution due to filler dispersion problems.

Another technique for cavitating films is “beta-cavitation.” The beta-cavitation process creates voids through first inducing the formation of beta-form polypropylene crystals within the polypropylene matrix, and second, converting the beta-form polypropylene crystals to alpha-form polypropylene crystals, which conversion simultaneously creates a cavity as a result of an increase in the density of the crystal. The first step of creating the beta-form polypropylene crystals may include introducing a beta-crystal nucleating agent or “beta-nucleator” within the polymer melt, prior to extrusion. The voids formed by beta-cavitation method tend to have a decreased average void size, more uniform void size, and increased number of voids as compared to voids created by conventional cavitating agents.

EP 0 865 909 of Davidson et al. discloses biaxially oriented, heat-shrinkable polyolefin films for use as labels, having a layer of a polypropylene-based resin with voids therein. The voids are formed by stretching a web containing the beta-crystalline form of polypropylene. EP 0 865 910 and EP 0 865 912, both of Davidson et al., disclose biaxially oriented polyolefin opaque films having a thickness of not more than 50 μm and having a layer of a polypropylene-based resin with voids therein. The voids are formed by stretching the web containing the beta-crystalline form of polypropylene. EP 0 865 911 of Davidson et al. discloses biaxially oriented polyolefin films containing a heat seal layer and a layer having voids formed therein by stretching the polypropylene-based resin of the layer, which contains the beta-crystalline form of polypropylene. The heat seal becomes transparent upon heating. EP 0 865 913 of Davidson et al. discloses biaxially oriented, heat-shrinkable polyolefin films having a layer of a polypropylene-based resin with voids therein. The voids are formed by stretching a web containing the beta-crystalline form of polypropylene.

EP 0 865 914 of Davidson et al. discloses biaxially oriented, high gloss polyolefin films having a layer of a polypropylene-based resin with voids therein and at least one olefin copolymer outer layer thereon. The voids have been formed by stretching a web containing the beta-crystalline form of polypropylene. U.S. Pat. No. 6,444,301 to Davidson et al. discloses polymeric films including a layer of propylene resin having voids therein, the voids having been formed by stretching a web containing the beta-form of polypropylene.

U.S. Pat. No. 5,594,070 to Jacoby et al. discloses oriented microporous films prepared from polyolefin resin compositions comprising an ethylene-propylene block copolymer having an ethylene content of about 10 to about 50 wt. %, a propylene homopolymer or random propylene copolymer having up to about 10 wt. % of a comonomer of ethylene or an α-olefin of 4 to 8 carbon atoms, and components selected from a low molecular weight polypropylene, a beta-spherulite nucleating agent and an inorganic filler. The microporous films are said to have improved breathability, strength, toughness, and break elongation. However, the films of Jacoby have a tendency to exhibit pink color when red dye (beta-spherulite nucleating agent) concentration is higher than 50 ppm. If the concentration of red dye (beta-spherulite nucleating agent) is lower than 50 ppm, then it is difficult to obtain consistent opacity due to poor dispersion uniformity.

Beta-crystal cavitation, including the use of a beta-crystal nucleating agent, is not without limitations and issues, as demonstrated within the various Davidson publications noted above. For further example, it can be difficult to sufficiently orient a polypropylene polymer film that has been voided by using a beta-cavitation method. Furthermore, orientation-processing conditions for a beta-crystal polypropylene film are typically quite narrow in comparison to the broader range of orientation conditions amenable for use with an alpha-crystalline polypropylene.

### SUMMARY OF THE INVENTION

An opaque polymer film containing at least one layer having a propylene polymer and impact copolymer blend matrix is provided, wherein the matrix is cavitated via beta-cavitation, and the film further comprises a skin layer having a relatively matte, rough or non-blocking exterior surface, as further defined below. Additionally, the film may further comprise a “support” layer on a side of the cavitated layer opposite the matte layer. The use of an impact copolymer (“IPC”) in conjunction with a beta-crystalline polypropylene cavitation may expand the processing window for producing beta-cavitated film, as compared to the processing window for producing polypropylene films not comprising the impact copolymer. The use of an IPC in conjunction with beta-cavitation may also facilitate enhanced appearance, applications, uses and performance, as compared to beta-cavitated films lacking an IPC.

In addition to the beta-cavitated IPC-containing layer, films according to this invention also comprise a skin layer that provides a relatively rough exterior surface on at least one side of the film. The rough surface may provide particular advantages and improvements in applications such as in-mold labeling. Suitably rough exterior surfaces may be described as matte-like or having a matte appearance. The rough surfaces may also comprise a particulate material to provide the desired surface roughness, such as an antiblocking agent. Regardless of whether or not an antiblock agent is actually present, due to the inherent benefit of improved non-blocking between labels made from films according to this invention, the layer containing the rough exterior surface may be referred to herein as a “matte” layer.

Additionally, the film may further comprise a support layer on a side of the cavitated layer opposite the matte layer. Films according to this invention may be particularly suited for labeling and thick film applications, such as IML. A desirable advantage to the roughened film surface is that such surface may permit improved “degassing” or evacuation of air or other gases from between the matte label surface and an external surface of a labeled container, as compared to IML labels lacking such surface. Whereas in the prior art, special coatings and/or an adhesive material were often applied in a selected pattern to facilitate degassing from beneath an applied IML label, with films according to this invention, the need for applying such coatings and/or the adhesives in any kind of regular pattern is reduced and/or eliminated. Labels made from the inventive films may be essentially mold-ready, without need for pattern coating or applying of an adhesive. Additionally, the film may further comprise a support layer on a side of the cavitated layer opposite the matte layer.

There is provided an opaque polymer film containing at least one layer having a propylene polymer and impact copolymer blend matrix, wherein the matrix is cavitated via beta-cavitation, and the film further comprising an additional layer having a matte-like or relatively rough exterior surface as compared to films having a relatively glossy or smooth surface. The present invention may provide a cavitated polymer film having relatively uniform opacity and improved mechanical properties, applications and uses as compared to prior art beta-cavitated films that lack the impact copolymer in the core layer and the matte-like surface on a skin layer.

### DETAILED DESCRIPTION OF THE INVENTION

The term “core layer” as used herein refers to the only layer of a monolayered film or the thickest layer of a multilayered film. In general, the core layer of a multilayer structure will be the innermost or more centrally positioned layer of the structure with respect to the other, more external layer(s) on one or each side of the core layer. It is understood that when a layer is referred to as being “directly on” another layer, no intervening layer(s) is/are present. On the other hand, when a layer is referred to as being “on” another layer, intervening layers may or may not be present.

The cavitated opaque polymer film includes a core layer. The core layer comprises a polymeric matrix containing a propylene polymer. The term “propylene polymer” as used herein includes homopolymers, as well as copolymers of propylene, wherein a copolymer not only includes polymers of propylene and another monomer, but also terpolymers, etc. However, in many preferred embodiments the propylene polymer is a propylene homopolymer. The propylene polymer of the core layer preferably has an isotacticity ranging from about 80 to 100%, preferably greater than 85%, most preferably about 95 to 96%, as measured by ¹³C NMR spectroscopy using meso pentads. A mixture of isotactic propylene polymers may be used. Preferably, the mixture comprises at least two propylene polymers having different m-pentads. Preferably, the difference between m-pentads is at least 1%. Furthermore, the propylene polymer of the core layer preferably has a melt index ranging from about 2 to about 10 g/10 minutes, most preferably from about 3 to about 6 g/110 minutes, as measured according to ASTM D1238 at 190° C. under a load of 5 lbs.

Commercially available propylene polymers that are suitable for the core layer of many embodiments may include PP 3371, an isotactic propylene homopolymer sold by Atofina Petrochemicals (Houston, Tex.), and PP 4712, an isotactic propylene homopolymer from ExxonMobil Chemical Company (Houston, Tex.).

Many preferred embodiments of the core layer may also comprise a beta-crystalline nucleating agent. Substantially any beta-crystalline nucleating agent (“beta nucleating agent” or “beta nucleator”) may be used.

U.S. Pat. Nos. 4,386,129 and 4,975,469 to Jacoby disclose processes of forming a film containing nucleating agents to produce beta-form polypropylene spherulites or crystals and then selectively extracting the beta-spherulites. Both Jacoby patents disclose quinacridone compounds, bisodium salts of o-phthalic acids, aluminum salts of 6-quinizarin sulfonic acid and isophthalic and terephthalic acids as beta nucleating agents.

U.S. Pat. No. 5,681,922 to Wolfschwenger et al. discloses the use of dicarboxylic acid salts of metals of the second main group of the Periodic Table as beta nucleating agents. Also, a two-component beta nucleator may be used as the beta nucleating agent of the invention. For example, U.S. Pat. No. 5,231,126 to Shi et al. discloses the use of a mixture of a dibasic organic acid and an oxide, hydroxide or salt of a metal of group IIA of the Periodic Table. When such beta-nucleator is used, the two-component beta nucleator still makes up only one component of the present method for producing the cavitated opaque polymer films of the invention.

U.S. Pat. Nos. 5,491,188; 6,235,823; and EP0632095; each of Ikeda et al., disclose the use of certain types of amide compounds as beta nucleators. U.S. Pat. No. 6,005,034 to Hayashida et al. discloses various types of beta nucleators. U.S. Pat. Nos. 4,386,129; 4,975,469; 5,681,922; 5,231,126; 5,491,188; 6,235,823; and 6,005,034; as well as EP 0632095, are herein incorporated by reference.

In many preferred embodiments, the beta-nucleating agent is a two-component beta-nucleator formed by the mixing of Components A and B. Component A may be an organic dibasic acid, such as pimelic acid, azelaic acid, o-phthalic acid, terephthalic and isophthalic acid and the like. Component B may be an oxide, hydroxide, or an acid salt of a Group II metal, e.g., magnesium, calcium, strontium, and barium. The acid salt of Component B may come from inorganic or organic acid such as carbonate, stearate, etc. Component B may also be one of the additives of polypropylene that already is present in the polypropylene material. By mixing the propylene polymer of the core layer with the beta nucleating agent of the core layer, suitable concentrations of the beta-crystalline form of polypropylene may be induced after the melting and subsequent cooling steps of the film-making process. Though use of a nucleator is preferred, creation of beta-form polypropylene may also be precipitated through careful control of thermal processing conditions.

The beta-crystalline form of polypropylene has a lower melting point and lower density than the common alpha-form of polypropylene. Conversion from beta- to alpha-form polypropylene results in creation of a slight void volume or cavity in the immediate vicinity of the converted spherulite crystal. This mechanism of creating cavities in polymer films due to conversion of polymer forms is referred to herein as “beta-cavitation” and the resulting product as “beta-cavitated.”

To create the beta-propylene crystals, use of a beta-nucleating agent or beta nucleator is preferred. When present, the amount of beta-nucleator to be included in the core layer should be enough to obtain the desired degree of void formation upon stretching. The amount of beta nucleator may also be used to control the degree of opacity and film density. Preferred amounts of beta nucleators may typically range from 0.005 to 1 wt %, based on the weight of the core layer, more preferably 0.015 to 0.1 wt %, most preferably 0.015 to 0.03 wt %. The invention also provides multilayer film structures wherein a layer(s) in addition to the core layer is also cavitated.

The core layer also comprises an impact copolymer (“IPC”). Substantially any impact copolymer may be used in the invention. Impact copolymers (or impact-modified polymers) are well known in the art as copolymer compositions containing a thermoplastic polymer first component and a second or copolymer component that improves the toughness and impact resistance of the polymer as compared to such properties of the thermoplastic first component without the second or copolymer component. The first component of the IPC may be essentially any application-compatible thermoplastic polymer, such as propylene or ethylene. Though a homopolymer may often be preferred, the first component may also include a copolymer content, such as at least 90 wt % polypropylene with less than about ten percent ethylene copolymer content. In some embodiments, the second component of the IPC may be an olefin copolymer, e.g., a co- or terpolymer composition, such as a propylene copolymer containing at least 10 wt % and preferably at least 20 wt % of comonomer content.

In other preferred embodiments, the second component of the IPC may be a rubber-like copolymer component that improves toughness and impact resistance. One type of impact copolymer that may be used in the invention comprises a polymer matrix, such as propylene, with a dispersed rubbery copolymer phase. The matrix is a homopolymer or random copolymer matrix. The dispersed rubbery, copolymer phase is a reactor blend of an amorphous rubber, a rubber-like polymer that is commonly an ethylene-propylene copolymer (“EPR” or “rubber”), and a semicrystalline ethylene copolymer. In one preferred embodiment, the impact copolymer is 8523, available from Basell, containing 25.3% ethylene-propylene rubber content. The amount of IPC to be included in the core layer depends on the EPR content in the particular IPC, and which IPC is used. The desired void percentage is also a factor. The EPR content may range from 1 to 50 wt % based on the total weight of the core layer. Preferably, the core layer contains from 1 to 20 wt % of EPR and more preferably from 1 to 10 wt %.

In other embodiments, the impact copolymer may be a non-rubber-like impact copolymer, such as an olefin polymer-based copolymer. For example, the impact copolymer may be a propylene-based impact copolymer, comprising a blend of propylene-containing polymers. Such propylene-based impact copolymer may comprise (i) from about 40 wt % to about 95 wt % based upon the weight of the impact copolymer of propylene homopolymer or copolymer wherein the copolymer contains less than about 10 wt % comonomer based upon the weight of the impact copolymer and (ii) from about 5 wt % to about 60 wt % based on the total weight of the impact copolymer of propylene copolymer, wherein the propylene copolymer comprises from about 20 wt % to about 70 wt % ethylene, butene, hexene, and/or octene comonomer and from about 80% to about 30% by weight propylene. Such impact copolymers are described in U.S. Pat. No. 6,342,566, to Burkhardt et. al., which is incorporated herein by reference.

Preferably, the propylene polymer, the impact copolymer and the beta-nucleator are blended together from one or more respective masterbatches and coextruded to form the core layer. For example, the core layer may comprise propylene polymer, an impact copolymer, and B-022-SP, a masterbatch of isotactic propylene homopolymer and beta-nucleating agent available from Sunoco.

This invention also provides multilayer film structures that are tailored for label applications, such as IML. One preferred label structure comprises (a) a core layer containing a polymeric matrix including a propylene polymer, a beta nucleating agent and an impact copolymer, (b) one or more matte layers on one side of the core layer, and (c) one or more print-side or “support” layers on an opposite side of the core layer. In such a preferred IML embodiment, each of the matte and support layers are provided directly on opposite sides of the core layer or, optionally, with one or more intermediate layers between either or each of the support and/or the matte layer and the core layer. The “support layer” may provide additional mechanical stiffness to the film, support print media and graphics, coatings, a metal layer, or otherwise facilitate improved application tailoring, performance, functionality, and film versatility.

Preferably, the support layer may comprise a polymeric matrix including any of the film-forming thermoplastic polymers that are suitable for the desired application, e.g., stiffness and printing. Exemplary suitable film-forming thermoplastic polymers include the olefinic polyolefins, such as propylene, ethylene butylene homo-, co-, or terpolymers, at least some of which may require surface treatment to increase surface energy for printing, coating, and/or metallization compatibility. In a particularly preferred embodiment, the support layer is a print-receiving skin layer comprising a propylene copolymer, such as, for example, PP 8573, an ethylene-propylene (EP) random copolymer available from Atofina Petrochemicals (Houston, Tex.), or Chisso 7701, an ethylene-propylene-butylene (EPB) terpolymer available from Chisso Corporation (Tokyo, Japan).

The matte layer also comprises a polymeric matrix comprising any of the film-forming thermoplastic polymers as discussed in regard to the support layer. Furthermore, the outer surface of the matte layer exhibits a relatively rough or irregular exterior film surface, as compared to the relatively smooth, glossy exterior film surface. The terms “rough,” “roughened,” “matte,” and “matte-like” may be used interchangeably to describe a surface demonstrating irregular surface uniformity of at least 0.5 μm. The exterior surface of the matte layer of a film according to the present invention having a matte surface may preferably have a surface roughness of 0.5 to 0.7 μm. A surface roughness of 0.5 to 0.7 μm may help evacuate or degas the air or other gasses that might otherwise become trapped between the label and the container surface during the container molding process. Degassing is important to avoid label blistering and to ensure proper adhesion and appearance. In addition to degassing the label during adhesion, the matte surface may also provide improved handling and sheetability for the film or labels, by providing an antiblocking effect.

The rough or matte surface may be accomplished by any of several techniques known in the art, as appropriate for the desired application. For example, a honeycomb or waffle pattern of a film-forming polymer having adhesive characteristics, such as an ethylene-vinyl acetate (EVA) copolymer, may be applied to one side of the core layer to provide the matte layer. Another technique may be to emboss a layer on one side of the film to form the matte layer.

Other techniques may also be utilized to create the matte surface. For example, a blend of two or more incompatible polymers, such as 3140 BA and 3420, available from Chisso, which when blended may produce a matte-like surface. 400700U (Matif 97), available from Ampacet, which comprises a blend of polymers may produce a matte layer. Antiblocking agents may also be applied in the matte layer and/or though not preferred, a coating may be applied in a pattern to the outer surface of the matte layer. U.S. Pat. No. 6,087,015 to Cretekos et al., which is incorporated herein by reference, provides some specific example of matte surface layers. Specifically, the matte layer may comprise a blend of (i) at least one of (1) a copolymer of ethylene and propylene, (2) a terpolymer of ethylene, propylene, and a C₄ to C₁₀ α-olefin, and (3) propylene homopolymer; and (ii) an ethylene polymer.

Alternatively, a matte layer may be provided by a layer comprising a polyolefin and a matte-producing “agent.” Exemplary suitable matte-producing agents may include materials such as aluminum oxide, aluminum sulfate, barium sulfate, magnesium carbonate, silicates, aluminum silicate (kaolin clay), magnesium silicate (talc), silicon dioxide, HDPE, polyesters, polybutylene terephthalate, styrenes, polyamides, and halogenated organic polymers. Suitable matte-producing agents also include calcium carbonate and titanium dioxide. Exemplary polyolefins suitable for the matte layer comprising a polyolefin and a matte-producing agent may include ethylene-propylene copolymers, propylene-butylene copolymers, ethylene-propylene-butylene terpolymers, polymers of ethylene, and copolymers of ethylene with another α-olefin.

An advantage provided by the matte surface of the film of this invention is that such surface may provide a mold-ready film having a sufficiently roughened surface to facilitate sheetability, degassing, and improved label-performance in IML applications. No separate surface preparation step, such as application of a patterned coating, is necessary. Additionally and surprisingly, sufficiently roughened or matte-like layers according to the invention (e.g., the matte layer) may have sufficient roughness that a relatively thin layer of a polymer, such as less than about 3 μm, especially a soft polymer, such as a soft, sealant polymer, can be used as an overlay directly on the matte resin-containing layer, and the combination of the matte layer and the polymer overlayer maintains a sufficient roughness to provide a mold-ready surface.

For some preferred embodiments, when the matte layer has no polymer overlayer, the matte layer may preferably have a thickness of 2 to 15 polygauge units (0.5 to 3.8 μm), more preferably a thickness of 8 to 12 polygauge units (2.0 to 3.0 μm). For other preferred embodiments where the matte layer has a polymer overlayer, the matte layer may preferably have a thickness of 5 to 50 polygauge units (1.3 to 12.7 μm), more preferably a thickness of 5 to 15 polygauge units (1.3 to 3.8 μm), and the polymer overlayer may have a thickness of 2 to 10 polygauge units (0.5 to 2.5 μm), more preferably a thickness of 3 to 5 polygauge units (0.8 to 1.3 μm).

As a result of the surface roughness provided by the matte layer, the labels from films according to the invention are mold-ready without the need for a backside pattern coating. The matte exterior surface is highly desirable because it enables elimination of an extra converting step. For example, where the matte layer is a matte resin-containing matte layer, for many in-mold labeling applications, it is no longer necessary to apply a stripe, honeycomb, or waffle pattern of a coating or film-forming polymer having adhesive characteristics, such as an ethylene-vinyl acetate (EVA) copolymer, to the outer surface of the matte layer. It is also now no longer necessary to emboss the outer surface of the film layer to produce the roughen surface.

The unique advantages attributable to use of a roughened layer of the invention in IML applications, such as blow molding and injection molding, are not limited to embodiments wherein the cavitated opaque polymer film has been cavitated via beta-nucleated (beta-crystalline) orientation in the presence of an impact copolymer. Accordingly, the present invention encompasses applications and methods of using film embodiments that include a roughened matte layer in in-mold labeling applications, wherein the cavitated opaque polymer film has been cavitated via a conventional cavitation method, such as films cavitated by using a PBT or CaCO₃ cavitating agent. However, the film compositions of this invention that also provide for a beta-cavitated film, in addition to the matte surface, enable film embodiments that exhibit improved appearance and opacity, reduced cost, and reduced extruder die-lip buildup and plate-out as compared to conventionally cavitated films.

According to other compositional embodiments, the matte layer may have adhesive characteristics or an adhesive layer may be provided on the matte surface to enhance label-container adhesion and/or bond strength. As used herein, the term “adhesive” shall mean and refer broadly to the ability of a material merely to bond with another material, whether like or different material, whether by cold-glue, hot-glue, melt adhesion, or any other bonding process. Any film-forming polymer having adhesive characteristics may comprise the matte layer. Particular examples of polymers that may be used to form a matte layer having desirable adhesive characteristics may include EP copolymers, PB copolymers, EPB terpolymers, HDPE's, LDPE homopolymers, LLDPE copolymers, ethylene plastomers, ethylene-vinyl acetate (EVA) copolymers, ethylene-acrylic acid (EAA) copolymers or terpolymers, and blends thereof. Still other examples include an (isotactic propylene)-α-olefin copolymer, a (syndiotactic propylene)-α-olefin copolymer, an ethylene-methacrylic acid copolymer (EMA), an ethylene methylacrylate acrylic acid terpolymer (EMAAA), an ethylene alkyl acrylate copolymer, an ionomer, such as ethylene-alkyl acrylate-acrylic acid Zn salt or Na salt, any metallocene plastomer, a very low density polyethylene (VLDPE), for example, having a density of 0.89 to 0.915 g/cc, an ethylene-(methyl acrylate)-(glycidyl methacrylate) terpolymer, and an ethylene-(glycidyl methacrylate) copolymer. In the case where the film-forming polymer used for the second layer does not have adequate adhesive characteristics, a separate adhesive may be provided on the side of the matte layer. The type of adhesive to be employed is not particularly limited. As an example, the adhesive may be a water-based adhesive, such as a cold glue adhesive or a polyvinylidene chloride latex.

As mentioned, the support and matte layers may be provided directly on opposite sides of the core layer or on opposite sides of the core layer with one or more intermediate layers there between. An intermediate or tie layer of the invention may comprise a polymeric matrix comprising any of the film-forming polymers. Suitable film-forming polymers for forming the polymeric matrix of the optional intermediate layer(s) may include polyolefins, such as polypropylene, syndiotactic polypropylene, polypropylene copolymers, low density polyethylene (LDPE), linear low density polyethylene (LLDPE), medium density polyethylene (MDPE), high density polyethylene (HDPE), ethylene copolymers, nylons, polymers grafted with functional groups, blends of these, etc. For example, an intermediate layer may comprise a polyolefin grafted with a functional group, such as ADMER 1179, a maleic anhydride-grafted polypropylene available from Mitsui Petrochemical Industries Ltd. (Tokyo, Japan).

One particularly preferred label structure includes at least one intermediate layer that serves as a pigmenting or whitening layer. For example, a whitening layer may be provided between the support layer and the core layer and/or between the matte layer and the core layer, wherein the whitening layer comprises a polymer and a whitening agent. Examples of the whitening agent include TiO₂ and CaCO₃. The polymer to be used is preferably a polyolefin. For example, the whitening layer may comprise a propylene homopolymer, such as PP 4712, an isotactic polypropylene from ExxonMobil, and TiO₂ or an ethylene-propylene copolymer and CaCO₃. 511094, a propylene polymer/TiO₂ masterbatch available from Ampacet, is one example of a suitable material to be included in a whitening layer. Any layer that improves the white appearance of the overall film structure may be employed as a whitening intermediate layer of the invention.

One or both outer (exterior with respect to the core layer) surfaces of the overall film structure may be surface-treated. In the case of a monolayer structure, the outer surfaces of the structure would simply be the exterior surfaces of the core layer. If the structure consists of a core layer and support layer, the outer surfaces would be the surface of the support layer opposite the core layer and the surface of the core layer opposite the support layer. If the structure contains a core layer and at least a support layer and a matte layer, the outer surfaces would be the surfaces of the support and matte layers that are respectively opposite from or most exterior with respect to, the core layer. The surface-treatment may be effected by any of various techniques, including, for example, flame treatment, corona treatment, and plasma treatment. In certain embodiments, the outer surface or surfaces may be metallized. Metallization can be effected by vacuum deposition or any other metallization technique, such as electroplating or sputtering. The metal may be aluminum or any other metal capable of being vacuum deposited, electroplated, or sputtered, for example, gold, silver, zinc, copper, or iron.

One or both outer surfaces of the overall film structure may be coated with a coating, such as a primer coating, (e.g., a polyvinylidene chloride (PVdC)), an acrylic, or a silicon oxide (SiOₓ) coating, which coating may be used to provide advantages and/or desirable functionality, such as printability, enhanced gloss and enhanced compatibility with manufacturing processes and machinery. In certain embodiments, priming the support layer, such as with an acrylic, can render it more receptive to printing. In addition, a coating, such as a cationic coating, e.g., a clay-based or clay-containing coating, may be applied to the outer surface of the support layer in order to improve the printability for various applications, such as UV flexographic and offset lithographic printing.

In order to modify or enhance certain properties of the overall film structure, it is possible for one or more of the layers to contain effective amounts of selected additives dispersed within the matrices of various layers of the film. Commonly preferred additives may include anti-blocks, anti-static agents, anti-oxidants, anti-condensing agents, co-efficient of friction (COF) modifiers (slip agents), processing aids, colorants, clarifiers, foaming agents, flame retardants, photodegradable agents, UV sensitizers or UV blocking agents, crosslinking agents, ionomers, and any other additives known to those skilled in the art.

For example, in certain embodiments, it may be desirable to include a coloring agent, such as a pigment or dye in one or more of the layers, such as a support layer (if present) or the tie layer between the core layer and the support layer. As another example, in certain embodiments having a support layer and especially certain label embodiments, the polymer matrix of the support layer may include dispersed therein one or more anti-block agents to prevent blocking or adherence between adjacent labels. To reduce friction or “grabbing” of the label or film on machine surfaces, one or more slip agents may be provided to improve the cold or hot slip on surfaces, such as heated metal surfaces. One or more anti-static agents may also be included to reduce static-cling between adjacent labels or film sheets, to improve sheetability. Specific examples of anti-block agents include coated silica, uncoated silica and crosslinked silicone. Specific examples of slip agents include silicone oils. Specific examples of anti-static agents include alkali metal sulfonates, tertiary amines, and the like. Exemplary anti-static agents may include Armostat 700 or Nourymix AP 475, which is available from AZKO Nobel.

A method of manufacturing a cavitated opaque polymer film according to this invention is also provided. One method for producing an embodiment of such films may comprise preparing, such as by coextruding, a single- or multi-layer melt(s) corresponding to the individual layer(s) of the desired film structure. The melts preferably may be cast-extruded into a sheet using a flat die or blown-extruded using a tubular die. The sheets may then be oriented uniaxially or biaxially by known stretching techniques. Preferably, the films are made by coextrusion and biaxial stretching of the layer(s). The biaxial orientation may be accomplished by either sequential or simultaneous orientation, as is known in the art. In particularly preferred embodiments, the film structure may be oriented from three to seven times in the machine direction and from four to twelve times in the transverse direction.

A preferred method of manufacturing a cavitated opaque film according to the present invention may comprise the steps of (a) extruding polymer melts through a die to form a film die-sheet, the film die-sheet comprising (i) a core layer comprising a propylene polymer and an impact copolymer and (ii) a matte layer; (b) creating at least some beta-form propylene polymer in the core layer; and (c) heating and/or orienting the film die-sheet comprising the beta-form propylene polymer to convert at least a portion of the beta-form propylene polymer into alpha-form propylene polymer, wherein the core layer contains at least a majority by volume of cavities formed in the core layer resulting from conversion of beta-form polypropylene to alpha-form polypropylene. The method may preferably further comprise providing a beta-nucleating agent in the core layer with the propylene polymer and the impact copolymer. In still further preferred embodiments, the method may further comprise extruding with the core layer and the matte layer, a support layer on a side of the core layer opposite the matte layer.

During the manufacturing process, if the cast temperature is set too low, i.e., quick quenching, the alpha crystalline form may dominate and the beta-crystalline form may be in the minority. Therefore, films according to the invention are preferably manufactured by setting the cast roll temperature at above 85° C., more preferably from 90° C. to 100° C. The nip roll against the cast roll is preferably set to a range of from 93° C. to 120° C. At these settings, beta-crystal formation is enhanced. Though the films can be cast with or without a waterbath, preferably the film is cast without a waterbath.

Impact copolymer is a key component of each cavitated layer in that it aids production and the beta-cavitation process. Specifically, the impact copolymer assists during the orientation process. With only polypropylene and beta-crystal nucleator (e.g., without the impact copolymer), reliably producing a biaxially oriented opaque film can be quite difficult, with quality and reliability problems such as film splits due to the high mechanical stress in the TD orientation. The addition of an impact copolymer in the beta-cavitated layer(s) improves the tenter frame orientation stability, especially in transverse orientation of greater than four times, reducing incidence of film splits and tears. Surprisingly, in addition to improving manufacturing and processing quality, the impact copolymer simultaneously facilitates production of suitable quantity of beta-crystallization and cavitation such that film opacity is not compromised. In comparison to conventionally cavitated films and films that are beta-cavitated without an impact copolymer, the films of the present invention having a core layer with a combination of (i) beta-crystallized polypropylene and (ii) impact copolymer retain a smoother appearance and do not buckle, crease, or permanently deform as much when subjected to the physical and thermal stresses present in IML operations.

Also, the average pore size of the voids in beta-cavitated films is much smaller than the average size of voids in conventionally cavitated films. As average pore size decreases, the ratio of solid polymer in contact with the void to the void volume increases. This results in greater mechanical, stiffness, support and greater resistance to permanent deformation when the film is subjected to bending and creasing stresses.

Furthermore, the beta-cavitated films of this invention have improved uniform whiteness and opacity in comparison to similar density conventionally cavitated films. Preferably, the light transmission of the inventive film, as measured by ASTM D1003, is less than 35%, more preferably less than 30%, and most preferably less than 25%. The beta-cavitated films of the invention also have improved elasticity, stiffness, appearance, and resistance to permanent deformation, rendering the films useful in many demanding labeling, bottling, and cut & stack applications. For many IML-appropriate films, the overall film density should range from 0.55 to 0.80 g/cm³, preferably from 0.65 to 0.75 g/cm³.

By tailoring the individual layers of a label, as has been discussed herein, the following additional advantages may be attained by employing a film according to the invention in an application such as in-mold labeling: (1) a smooth, glossy label useful for a variety of bottling applications; (2) less buckling, blistering, deformation, and creasing versus previously existing IML film structures; (3) consistent level 1 scanning of UPC barcodes off labels (any significant wrinkling may give an erroneous scan reading); (4) lower cost (versus conventionally cavitated IML films), with increased yield and overall performance; (5) good feeding and sheetability, enabling improved processing and labeling speed; and (6) good adhesive characteristics to containers. However, in addition to IML, other applications are also foreseeable for films according to this invention, including photographic markets, ink jet and digital print media, posters, business cards, and markets requiring a film that is both very white and relatively stiff. In general, the films of this invention can be useful for substantially any thick film (greater than 3.5 mils or 90 μm) application that requires retention of stiffness after cavitation.

Total thickness of a film according to the invention is not particularly limited but will be dictated by the desired application. As has been mentioned, the overall thickness may typically be greater than 3.5 mils (90 μm). Preferably, the film has an overall thickness of 3.5 mils to 8.0 mils, optical gauge (90 to 200 μm). Preferably, the thickness of each layer, as measured after cavitation (optical gauge), ranges from 300 to 366 gauge units (76 to 93 μm) for the core layer; from 2 to 20 gauge units (0.5 to 5.1 μm) for the support layer (if present); from 2 to 20 gauge units (0.5 to 5.1 μm) for the matte layer (if present); and from 5 to 35 gauge units (1.3 to 8.9 μm) for an intermediate layer (if present).

The present invention will be further described with reference to the following nonlimiting example.

### EXAMPLE

A five-layer coextruded film was manufactured having the following structure:

| | |
|---|---|
| Support layer | Atofina 8573 (an EP random copolymer); |
| | 5 gauge units |
| Whitening intermediate layer | 92% Atofina 3371 (a PP homopolymer) + |
| | 8% Ampacet 511094 TiO₂ masterbatch; |
| | 20 gauge units |
| Core layer | 30% Atofina 3371 + 30% Basell 8523 |
| | (an impact copolymer) + 40% Sunoco |
| | B-022-SP beta nucleator; 255 polymer |
| | gauge units (330 optical gauge) |
| Intermediate layer | Atofina 3371; 20 gauge units |
| Matte layer | Chisso 3140 BA matte resin; 5 gauge |
| | units |

Selected critical physical properties of the prepared five-layered film were measured and compared to a commercial film. The commercial film is a three-layer, high-density polyethylene film coated on two sides with a clay-filled coating. The conventionally cavitated core layer of the commercial film contains HDPE and CaCO₃. The clay-coated outer layers of the commercial film contain HDPE and TiO₂. Results from the comparison are as follows:

| Property | Commercial Film | Example: 5-layered film |
|---|---|---|
| Yield (in²/lb.) | 9,400 | 11,530 |
| Light transmission (%) | 20.0 | 9.6 |
| Optical gauge (mils) | 3.80 | 3.83 |

The exemplary film according to this invention demonstrates an improved yield and light transmission as compared to the commercial film, at substantially the same optical gauge for both films.

While the invention has been described in detail and with reference to specific embodiments thereof, it will be apparent to one of ordinary skill in the art that various changes and modifications can be made therein without departing from the spirit and scope of the invention. The Example recited herein is demonstrative only and is not meant to be limiting.

What is claimed is:

1. A cavitated opaque film, comprising:
a core layer comprising a propylene polymer and an impact copolymer, wherein the core layer is beta-cavitated; and
a matte layer on a side of the core layer, the matte layer comprising a thermoplastic polymer.

2. The cavitated opaque film of claim 1, further comprising:
a support layer on a side of the core layer opposite the matte layer.

3. The cavitated opaque film of claim 1, wherein the core layer further comprises a beta-nucleating agent.

4. The cavitated opaque film of claim 1, further comprising one or more intermediate layers between the core layer and the matte layer.

5. The cavitated opaque film of claim 2, further comprising one or more intermediate layers between the core layer and the support layer.

6. The cavitated opaque film of claim 1, wherein the impact copolymer comprises: (i) from about 40 wt % to about 95 wt % based upon the weight of the impact copolymer of propylene homopolymer or copolymer wherein the copolymer contains less than about 10 wt % comonomer based upon the weight of the impact copolymer and (ii) from about 5 wt % to about 60 wt % based on the total weight of the impact copolymer of propylene copolymer, wherein the propylene copolymer comprises from about 20 wt % to about 70 wt % ethylene, butene, hexene and/or octene comonomer and from about 80% to about 30% by weight propylene.

7. The cavitated opaque film of claim 1, wherein the impact copolymer comprises an ethylene-propylene rubber (EPR) and the EPR comprises from 1 wt % to 50 wt % of the total weight of the core layer.

8. The cavitated opaque film of claim 1, wherein the impact copolymer comprises a polymer comprising an ethylene-propylene rubber (EPR) and the EPR comprises from 1 to 10 wt % of the total weight of the core layer.

9. The cavitated opaque film of claim 2, wherein the support layer comprises a polymer, the polymer comprising at least one of a propylene homo-, co-, or terpolymer, an ethylene copolymer, an ethylene-propylene (EP) random copolymer or an ethylene-propylene-butylene (EPB) terpolymer.

10. The cavitated opaque film of claim 1, wherein the matte layer comprises a polymer selected from the group consisting of an EP copolymer, a PB copolymer, an EPB terpolymer, a HDPE, a LDPE homopolymer, a LLDPE copolymer, an ethylene plastomer, an ethylene-vinyl acetate (EVA) copolymer, an ethylene-acrylic acid (EAA) copolymer or terpolymer, and blends thereof.

11. The cavitated opaque film of claim 1, wherein the matte layer comprises a blend of (i) at least one of (1) a copolymer of ethylene and propylene, (2) a terpolymer of ethylene, propylene and a C₄ to C₁₀ α-olefin and (3) propylene homopolymer and (ii) an ethylene polymer.

12. The cavitated opaque film of claim 1, wherein the matte layer comprises (i) a polymer selected from the group consisting of an ethylene-propylene copolymer, a propylene-butylene copolymer, an ethylene-propylene-butylene terpolymer, an ethylene polymer, and a copolymer of ethylene with another α-olefin and (ii) a matte-producing agent.

13. The cavitated film of claim 1, wherein the matte layer further comprises a matte-producing agent.

14. The cavitated opaque film of claim 13, wherein the matte-producing agent is selected from the group consisting of aluminum oxide, aluminum sulfate, barium sulfate, magnesium carbonate, a silicate, silicon dioxide, HDPE, a polyester, a styrene, a polyamide, a halogenated organic polymer, calcium carbonate and titanium dioxide.

15. The cavitated opaque film of claim 1, wherein the matte layer comprises a polymer selected from the group consisting of an (isotactic propylene)-α-olefin copolymer, a (syndiotactic propylene)-α-olefin copolymer, an ethylene-methacrylic acid copolymer (EMA), an ethylene methylacrylate acrylic acid terpolymer (EMAAA), an ethylene alkyl acrylate copolymer, an ionomer, a metallocene plastomer, a very low density polyethylene (VLDPE), an ethylene-(methyl acrylate)-(glycidyl methacrylate) terpolymer, and an ethylene-(glycidyl methacrylate) copolymer.

16. The cavitated opaque film of claim 1, further comprising an adhesive on a side of the matte layer opposite the core layer.

17. A label, comprising the opaque cavitated film of claim 1.

18. The label of claim 17, having an overall thickness of from 3.5 mils to 8 mils.

19. A method of manufacturing a cavitated opaque film comprising the steps of:
(a) extruding polymer melts through a die to form a film die-sheet, the film die-sheet comprising:
(i) a core layer comprising a propylene polymer and an impact copolymer; and
(ii) a matte layer;
(b) creating at least some beta-form propylene polymer in the core layer; and
(c) heating and/or orienting the film die-sheet comprising the beta-form propylene polymer to convert at least a portion of the beta-form propylene polymer into alpha-form propylene polymer, the core layer having at least a majority by volume of cavities formed in the core layer resulting from conversion of beta-form polypropylene to alpha-form polypropylene.

20. The method of claim 19, further comprising providing a beta-nucleating agent in the core layer with the propylene polymer and the impact copolymer.

21. The method of claim 19, further comprising extruding with the core layer and the matte layer a support layer on a side of the core layer opposite the matte layer.

22. A cavitated opaque film, comprising:
a beta-cavitated core layer;
a support layer on a side of the core layer, the support layer comprising a thermoplastic polymer; and
a matte layer on a side of the core layer opposite the support layer, the matte layer comprising a mixture of incompatible resins to produce a matte surface on an external side of the matte layer.

23. The cavitated opaque film of claim 22, wherein the beta-cavitated core layer comprises a propylene polymer, a beta nucleating agent, and an impact copolymer.

24. The cavitated opaque film of claim 22, wherein the core layer comprises a thermoplastic polymer and a cavitating agent, the cavitating agent selected from the group consisting of PBT and CaCO₃.

25. The cavitated opaque film of claim 22, further comprising an intermediate layer between the core layer and the support layer, the first intermediate layer comprising a propylene polymer and a whitening agent.

26. The cavitated opaque film of claim 25, further comprising an intermediate layer between the core layer and the matte layer, the intermediate layer comprising a propylene polymer.

27. The cavitated opaque film of claim 22, further comprising an overlayer on a side of the matte layer opposite the core layer, the overlayer comprising a thermoplastic polymer.

28. The cavitated opaque film of claim 22, wherein an outermost surface of the film on the matte layer side of the film does not have a selected pattern coating provided thereon.
